(19) United States
(12) Patent Application Publication
(10) Pub. No.: US 2021/0022418 A1
(43) Pub. Date: Jan. 28, 2021

(54) DISPOSABLE MASK

(71) Applicant: UNICHARM CORPORATION, Ehime (JP)

(72) Inventors: Kaori Furuya, Kagawa (JP); Akira Shibata, Kagawa (JP)

(73) Assignee: UNICHARM CORPORATION, Ehime (JP)

(21) Appl. No.: 17/069,234

(22) Filed: Oct. 13, 2020

Related U.S. Application Data
(63) Continuation of application No. PCT/JP2018/017094, filed on Apr. 26, 2018.

(30) Foreign Application Priority Data
Apr. 13, 2018 (JP) 2018-078028

(51) Int. Cl. A41D 13/11

(52) U.S. Cl. CPC A41D 13/1161; A41D 13/1115

(57) ABSTRACT

A disposable mask having a vertical direction and a width direction, includes: a mask body formed of a body sheet; and a pair of ear looping straps that extends from both of side edges of the mask body. The mask body includes a plurality of pleat portions formed by folding the body sheet in a pleated shape; and a lower end edge that includes a central part that is convex upwardly.

### BACKGROUND

### Technical Field

The present invention relates to a disposable mask.

### Related Art

Conventional disposable masks include a mask body and a pair of ear looping straps annularly extending from both side edges of the mask body (see Patent Literature 1).

### PATENT LITERATURE

Patent Literature 1: Japanese Unexamined Patent Publication No. 2011-182810

In the disposable mask disclosed in Patent Literature 1, a mouth-nose covering portion of the mask body has a plurality of pleat portions formed by folding a sheet forming the mask body in a pleated shape, and the entire portions of wearer's mouth and nose can be covered by extending an extension area in which the pleat portions can be extended in the vertical direction during wearing.

In such a mask, since the upper and lower end edges of the mask body have a shape that linearly extends in a width direction, in a state before putting on, the central area of the mask body, in which the extension area of the pleat portions is located, and the both side areas, of which pleat portions being fixed thereto, have the same vertical dimension, however when putting on, the extension area is extended so that the vertical dimension of the central area is also increased.

In a case where a wearer is a child who has a round and relatively small chin, the central area of the mask body extending downwardly may extend further from the wearer's chin to the throat, which may cause discomfort to the wearer.

In order to avoid such a situation, in a case where the vertical dimension of the entire mask body is reduced, there is a possibility that the wearer's mouth and nose may not be sufficiently covered.

### SUMMARY

One or more embodiments improve a conventional mask and provide a disposable mask which is capable of sufficiently covering the wearer's mouth and nose with the mask body, and is capable of fitting an appropriate position under the chin.

One or more embodiments relate to a disposable mask having a vertical direction and a width direction and including a mask body and a pair of ear looping straps extending from both side edges of the mask body.

In the disposable mask according to one or more embodiments, the mask body includes a plurality of pleat portions formed by folding a body sheet forming the mask body in a pleated shape, and a lower end edge of the mask body includes a central part which is convex upwardly.

The disposable mask according to one or more embodiments includes the following embodiments.

(1) The central part of the lower end edge is located between lower fixed ends of the pair of ear looping straps in the width direction, and an uppermost portion located at an uppermost position in the central part is located below an upper edges of the lower fixed ends of the ear looping straps.

(2) The mask body includes a lower seal area extending along the central part of the lower end edge, and a lateral seal portions lying above the lower seal area and extending inwardly from the respective side edges of the mask body in the width direction, and the lower fixed ends of the ear looping straps are surrounded by the lower seal area and the lateral seal portion.

(3) The disposable mask further includes a lower fixing portion for fixing the lower fixed ends of the pair of ear looping straps to the mask body, and a part of the lower fixing portion and a part of the lateral seal portion are overlapped with each other.

(4) A spaced dimension in the vertical direction is 5 to 15 mm between an imaginary line linearly extending in the width direction with connecting both ends of the central part and the uppermost portion.

(5) The pleat portion includes a first pleat portion, a second pleat portion, a third pleat portion, and a fourth pleat portion that are arranged in order in the vertical direction. The second pleat portion and the third pleat portion forms a folded area having a substantially Ω-shaped in cross section, and a side joining portion forming a side seal area is not disposed in a central area where the body sheet is not folded in the folded area, and is not disposed between a position of an outer folded portion extending in the width direction on an outer surface of the mask body of the third pleat portion and a position of an inner folded portion extending in the width direction on an inner surface of the mask body of the fourth pleat portion.

(6) The pleat portion includes an upper pleat portion lying above a lateral centerline bisecting a dimension of the mask body in the vertical direction into two equal parts, and a pair of pleat adjusting means opposed to each other in the width direction are arranged in the upper pleat portion so as to suppress the extension thereof.

According to the disposable mask of one or more embodiments, the mask body includes a plurality of pleat portions formed by folding the body sheet in a pleated shape, and the lower end edge of the mask body includes a central part being convex upwardly. Therefore, in state of being worn, the mask body fits the wearer's face, and the lower end edge of the mask body extends in the width direction at an appropriate position under the chin, so that the chin is firmly covered not to cause discomfort to the wearer.

### BRIEF DESCRIPTION OF THE DRAWINGS

The drawings illustrate one or more embodiments and include selective configurations as well as essential configurations of a disposal mask.

FIG. 1 is a plan view of a disposable mask according to a first embodiment as viewed from the front.

FIG. 2 is an enlarged plan view of a mask body.

FIG. 3A is a perspective view of one side portion of the mask cut along a line III-III (a) in FIG. 2 as viewed from an outer surface. FIG. 3B is a partially enlarged view of an area surrounded by a dashed line III (b) of FIG. 3A.

FIG. 4 is a side view of the mask in a state of being worn.

FIG. 5 is a view of the mask as viewed from below in a state of being worn.

FIG. 6 is a plan view of a disposable mask according to a second embodiment.

FIG. 7 is a vertical cross-sectional view of the disposable mask according to the second embodiment in a state of being worn.

FIG. 8 is a plan view of a disposable mask according to a third embodiment.

### DETAILED DESCRIPTION

Embodiments of the present invention will be described herein with reference to the drawings. Those skilled in the art will recognize that many alternative embodiments can be accomplished using the teaching of the present invention and that the present invention is not limited to the embodiments illustrated herein for explanatory purposes.

### First Embodiment

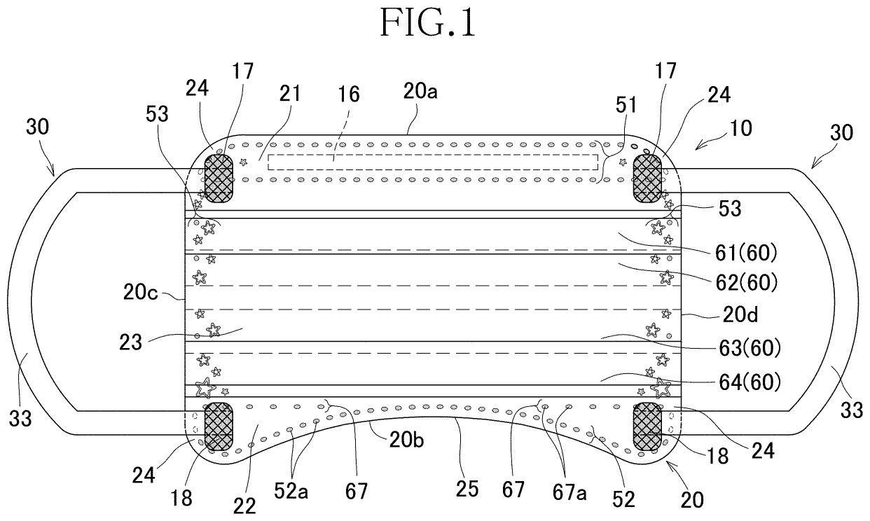

Referring to FIGS. 1 to 4, a mask 10 according to the first embodiment as an example of a disposable mask of one or more embodiments, has a vertical direction (longitudinal direction) Y and a width direction X and includes a skin-facing surface (inner surface), a non-skin facing surface (outer surface) opposed thereto, a lateral centerline Q bisecting the dimension in the vertical direction Y, a mask body 20, and a pair of annular ear looping straps 30 extending from both side edges 20c and 20d of the mask body 20.

The mask body 20 is formed of a body sheet, and includes an upper end edge 20a linearly extending in the width direction X, a lower end edge 20b extending in the width direction X, and both side edges 20c and 20d extending in the vertical direction Y between the upper end edge 20a and the lower end edge 20b.

Further, the mask body 20 includes an upper end portion 21 extending in the width direction X along the upper end edge 20a, a lower end portion 22 extending in the width direction X along the lower end edge 20b, and a mouth-nose covering portion 23 located between the upper end portion 21 and the lower end portion 22.

The mask body 20 further includes a curved corner portion 24 at which the upper and lower end edges 20a and 20b intersect with the both side edges 20c and 20d.

The corner portion 24 has not a sharpened but a curved shape and causes no irritation even if the wearer's face touches the corner portion 24.

The lower end edge 20b of the mask body 20 has a shape gently curved upward.

Specifically, the lower end edge 20b includes a central part 25 extending in the width direction X between the corner portions 24 having a shape being convex downwardly and having a shape being convex upwardly.

Both ends 25a and 25b of the central part 25 are the starting points in the width direction X of the central part 25, and are intersecting points of a contour line of the corner portions 24 with a contour line being curved upwardly. A length dimension L2 of the central part 25 has a length of the contour line being curved upwardly between both ends 25a and 25b.

In this manner, since the central part 25 of the lower end edge 20b has a shape being convex upwardly, it can be said that the central part of the lower end portion 22 of the mask body 20 also has a shape being convex upwardly in the same way.

The corner portion 24 has a shape being convex downwardly, and may have, for example, an angular shape with a part forming the lower end edge 20b extending substantially linearly in the width direction X. In such a case, the central part 25 of the lower end edge 20b is convex upwardly, and the portions located on both sides in the width direction X are linear both side parts.

Here, the lateral centerline Q bisects the dimension of the mask body 20 in the vertical direction Y, however, as in one or more embodiments, in a case where the lower end edge 20b has a shape being convex upwardly it can be said that the dimension of the mask body 20 in the vertical direction Y is not constant.

The lateral centerline Q bisects a spaced dimension between the uppermost portion and the lowermost portion of the mask body 20, and, in one or more embodiments, it can be said that the dimensions in the vertical direction Y of both side edges 20c and 20d extending in parallel in the vertical direction Y are bisected.

The mask 10 can be used regardless of age and sex of adults and children, regardless of men and women of all ages. For example, a dimension W1 of the mask body 20 in the vertical direction Y is 75 to 100 mm and a dimension L1 in the width direction X is 115 to 185 mm.

However, in a case where it is used as a so-called child's mask for the younger age group of 6 to 9 years old, that is, the mask 10 is used for children, the mask body 20 may have the dimension W1 (length dimension of both side edges 20c and 20d) in the vertical direction Y is 75 to 95 mm and a dimension L1 (the length dimension of the upper and lower end edges 20a and 20b) in the width direction X is 115 to 135 mm.

Since the central part 25 of the lower end edge 20b thus has a shape curved upwardly, the length dimension in a case where the central part 25 extends linearly in the width direction X, that is, a length dimension L2 is larger than a length dimension L3 of an imaginary line K1 connecting both ends 25a and 25b with a straight line.

For example, in the mask 10 for children, in a case where the length dimension L3 of the imaginary line K1 is 105 to 125 mm, the length dimension L2 of the central part 25 is 110 to 133 mm, which is longer than the length dimension L3 by about 5 to 8 mm.

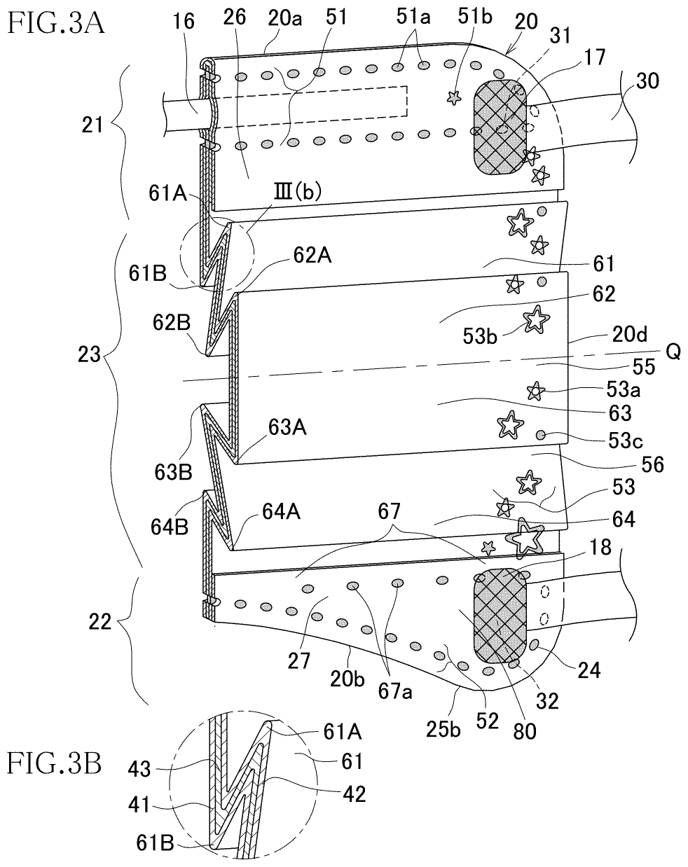

Referring to FIG. 3B, the body sheet for forming the mask body 20 includes an inner layer sheet 41 located on the skin-facing surface side, an outer layer sheet 42 located on the non-skin facing surface side, and an intermediate layer sheet 43 located between the inner and outer layer sheets 41 and 42.

The inner and outer layer sheets 41 and 42 and the intermediate layer sheet 43 are, for example, fiber non-woven fabric sheets containing a thermally fused fiber and having a mass of 10 to 40 g/m2 with air permeability, and in addition to various known fiber non-woven fabrics such as meltblown fiber non-woven fabric, spunbond fiber non-woven fabric, SMS fiber non-woven fabric, and air-through fiber non-woven fabric, it can be formed of a sheet material having excellent air permeability such as gauze and cotton cloth.

As the intermediate layer sheet 43, a non-woven fabric may be used to provide with a filtering function to block passage of fine particles.

In the mask body 20 of one or more embodiments, for example, as the outer layer sheet 42, a spunlace non-woven fabric or spunbond non-woven fabric having a mass of 20 to 45 g/m2 is used, as the intermediate layer sheet 43, a meltblown non-woven fabric having a mass of 20 to 30 g/m2 is used, and as the inner layer sheet 41, a spunbond non-woven fabric having a mass of 20 to 30 g/m2 is used.

In addition to the illustrated example, the mask body 20 may be formed of a sheet laminated with two or three or more layers. For example, in addition to having a function of filtering fine particles between the inner and outer layer sheets 41 and 42, a plurality of intermediate layer sheets 43 containing an antibacterial agent, an aromatic agent, and the like may be interposed therebetween.

The mask body 20 includes an upper folded part 26 formed at the upper end portion 21 by folding a part of the inner layer sheet 41 and a part of the intermediate layer sheet 43 toward the outer surface of the mask body 20 and downwardly through the upper end edge of the outer layer sheet 42, and a lower folded part 27 formed at the lower end portion 22 by folding a part of the outer layer sheet 42 toward the outer surface of the mask body 20 and upwardly along the lower end edge 20b of the mask body 20.

The inner and outer layer sheets 41 and 42 and the intermediate layer sheet 43 are joined to each other by an outer peripheral seal area 50 extending intermittently along the outer peripheral edge of the mask body 20.

The outer peripheral seal area 50 includes an upper seal area 51 formed of two lines extending intermittently in the width direction X along the upper end edge 20a of the mask body 20, a lower seal area 52 intermittently extending in the width direction X along the lower end edge 20b, and a side seal area 53 intermittently extending in the vertical direction Y along both side edges 20c and 20d.

The outer peripheral seal area 50 is a sealing line that seals the inner and outer layer sheets 41 and 42 and the intermediate layer sheet 43 to each other at a plurality of intermittently arranged joining portions, and the sheets 41 to 43 are joined only in the outer peripheral seal area 50 and are not joined to each other in other portions.

Therefore, the mask 10 as a whole is excellent in the flexibility and air permeability as compared with a case where the entire inner surfaces of the sheets 41 to 43 are joined to each other.

The joining portions 51a and 52a forming the upper seal area 51 and the lower seal area 52 have a substantially elliptical shape that is long in the width direction.

On the other hand, the side seal area 53 is formed by joining portions 53a and 53b having a small and large substantially star shape and a joining portion 53c having a substantially circular shape.

Unlike the upper and lower seal areas 51 and 52, the side seal area 53 is formed by a plurality of designed joining portions 53a to 53c, so that the mask 10 is superior in the design properties in a front view and a side view, as compared with a case where the entire outer peripheral seal area 50 is formed only by a substantially circular or elliptical joining portion.

Further, in the side seal area 53, the side joining portions 53a to 53c arranged at the one side edge 20c of the mask body 20 and the side joining portions 53a to 53c arranged at the other side edge 20d are arranged substantially symmetrically so as to have a unity in design.

An elastic strip (nose fit) 16 extending in the width direction X is disposed between the two sealing lines in the upper seal area 51.

The elastic strip 16 is interposed between the outer layer sheet 42 and the upper folded part 26, and specifically, it is inserted into and fixed within a tubular space formed between the two sealing lines forming the upper seal area 51.

The joining portions 51b are arranged outside the both ends of the elastic strip 16 in the width direction X so as to control the movement of the elastic strip 16 in the width direction X.

The ear looping strap 30 is formed of various known elastic materials such as a non-woven fabric, a woven fabric, a plastic film, an elastic cord, and a woven string, and includes a pair of upper and lower fixed ends 31 and 32 located at the upper end portion 21 and the lower end portion 22 of the mask body 20, and a free portion 33 annularly extending between the upper and lower fixed ends 31 and 32.

The upper fixed end 31 of the ear looping strap 30 is fixed onto the outer surface of the upper end portion 21 of the mask body 20 via an upper fixing portion 17, and the lower fixed end 32 is fixed onto the outer surface of the lower end portion 22 of the mask body 20 via a lower fixing portion 18.

In one or more embodiments, a woven string having a width dimension of 4 to 8 mm is used as the ear looping strap 30.

In this way, by using a relatively wide woven string instead of the elastic cord, it gently touches the wearer's ear with no rubber marks left, and is unlikely to be broken or stretched out even if a child wearer handles it roughly.

The upper and lower fixing portions 17 and 18 are slightly larger than the upper and lower fixed ends 31 and 32 of the ear looping strap 30 and have a substantially rectangular shape with a mesh embossed pattern, and the upper and lower fixed ends 31 and 32 are adhered or sealed to the mask body 20.

Since the upper and lower fixing portions 17 and 18 are larger than the outer shapes of the upper and lower fixed ends 31 and 32 of the ear looping strap 30, the upper and lower fixed ends 31 and 32 have a required peeling strength with respect to the mask body 20 and are unlikely to be peeled off even if a peeling force is acted during wearing.

In addition, a part of the upper and lower fixing portions 17 and 18 are overlapped with the joining portions 51a and 52a forming the upper and lower seal areas 51 and 52, and the joining strength is increased in the overlapped portions.

The upper and lower fixed ends 31 and 32 of the ear looping strap 30 are fixed to the non-skin facing surface of the mask body 20 by the upper and lower fixing portions 17 and 18.

In this manner, since the upper and lower fixed ends 31 and 32 which are both end parts of the free portion 33 of the ear looping strap 30 are fixed to the non-skin facing surface of the mask body 20, in the state of being worn, the upper and lower fixed ends 31 and 32 act to press the mask body 20 against the face and enable the mask body 20 to fit more closely to the face as compared with a case where they are fixed to the inner surface side of the mask body 20.

A lateral seal portion 67 extending intermittently in the width direction X is disposed above both sides of the lower seal area 52.

The lateral seal portion 67 is for fixing the upper end edge portion of the lower folded part 27, and in an area 80 located between the lateral seal portion 67 extending linearly in the width direction X and the lower seal area 52 extending upwardly with a curve along the lower end edge 20b, the lower fixed end 32 of the ear looping strap 30 is attached to the outer surface of the mask body 20 via the lower fixing portion 18 so as to be surrounded thereby.

The lateral seal portion 67 is formed by a plurality of joining portions 67a arranged at intervals in the width direction X, and a part of the joining portion 67a is overlapped with the lower fixing portion 18.

In this way, the joining portion 67a of the lateral seal portion 67 and the lower fixing portion 18 are overlapped with each other, so that a locally higher rigidity part is formed in the lower fixing portion 18, and the mask body 20 can be more stably pressed against the face via the lower fixed end 32 of the ear looping strap 30.

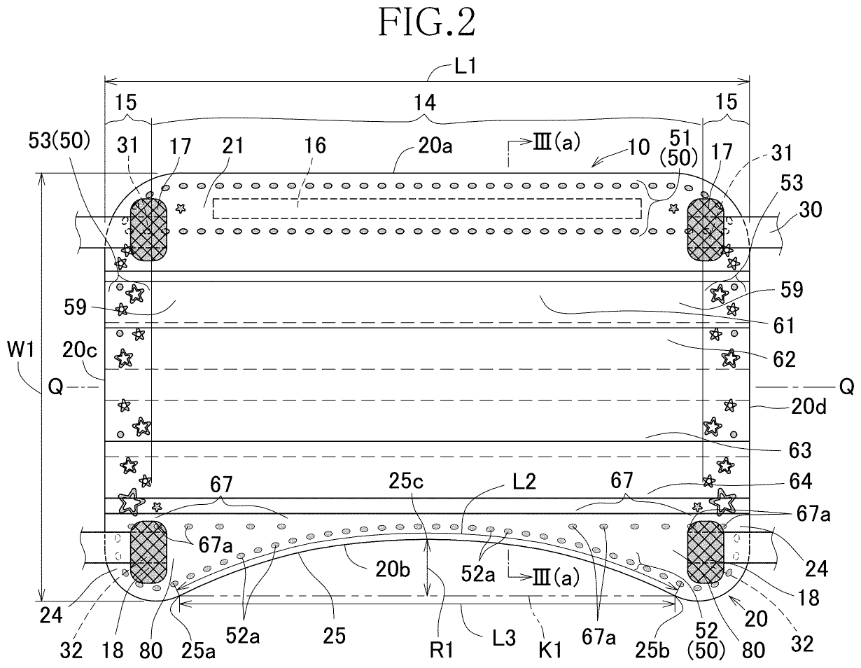

Referring FIGS. 2 and 3, the mouth-nose covering portion 23 of the mask body 20 has a plurality of pleat portions 60 extending in the width direction X formed by folding the body sheet in a pleated shape.

The pleat portion 60 has a first pleat portion 61, a second pleat portion 62, a third pleat portion 63, and a fourth pleat portion 64, which are arranged in order from the upper end edge 20a side to the lower end edge 20b side of the mask body 20.

Each of the pleat portions 61 to 64 is folded in a pleated shape so as to be folded up and down in different directions on the outer surface side and the inner surface side of the mask body 20. The first pleat portion 61 includes an outer folded portion 61A located on the outer surface side and being convex upwardly, and an inner folded portion 61B located on the inner surface side and being convex outwardly, the second pleat portion 62 includes an outer folded portion 62A located on the outer surface side and being convex upwardly and an inner folded portion 62B located on the inner surface side and being convex downwardly, the third pleat portion 63 include an outer folded portion 63A located on the outer surface side and being convex downwardly and an inner folded portion 63B located on the inner surface side and being convex upwardly, and the fourth pleat portion 64 includes an outer folded portion 64A located on the outer surface side and being convex downwardly, and an inner folded portion 64B located on the inner surface side and being convex upwardly.

In the present specification, among the pleat portions 60, a pleat portion located above the lateral centerline Q is also referred to as an upper pleat portion, and the pleat portion located below the lateral centerline Q is also referred to as a lower pleat portion.

In one or more embodiments, the first and second pleat portions 61 and 62 are the upper pleat portions, and the third and fourth pleat portions 63 and 64 are lower pleat portions, and the upper pleat portions may be one or two or more pleat portions and the lower pleat portions may be one or two or more pleat portions.

In the mask body 20 of one or more embodiments, on the outer surface side, the second pleat portion 62 is convex upwardly, and the third pleat portion 63 facing the second pleat portion 62 is convex downwardly, and thus a folded area folded in a cross sectional Ω-shape is formed in the central area of the mask body 20, so that a relatively large internal space can be formed when the mask body 20 is worn.

In the first to fourth pleat portions 61 to 64, the folded state of the body sheet is maintained in the side seal area 53 and is a non-extended area, whereas, the area between the side joining portions 53a to 53c constituting side seal area 53 is an extension area which is extendable in the vertical direction.

Specifically, the extension area is the area between the inner edges of the side joining portions 53a to 53c located on the innermost side in the width direction X among the side joining portions 53a to 53c located in the pleat portions 61 to 64.

For example, in the fourth pleat portion 64, the extension area is the area between the side joining portions 53a located on the innermost side in the width direction X.

Referring to FIGS. 3A-3B, the side joining portions 53a to 53c are located between the second pleat portion 62 and the third pleat portion 63, and not arranged in a non-folded part 55 where the body sheet is not folded, and in a part 56 lying between the outer folded portion 63A of the third pleat portion 63 and the inner folded portion 64B of the fourth pleat portion 64.

Since the side joining portions 53a to 53c are not arranged in these parts 55 and 56, the both side edge portions of the mask body 20 can be folded from these parts 55 and 56 as a starting point by the rearward tensile force of the ear looping strap 30.

In this way, by controlling the starting points of folding both side edge portions of the mask body 20, the mask body 20 can be made to conform to the shape of the wearer's face.

Referring to FIG. 2, the mask body 20 is divided into a central area 14 and both side areas 15 located on both sides of the central area 14 in the width direction X for convenience of description.

The central area 14 means an area in which the extension areas of the first to fourth pleat portions 61 to 64 are located and can be completely extended in the worn state.

On the other hand, the both side areas 15 are areas located between the central area 14 and the both side edges 20c and 20d of the mask body 20, and means areas including the side seal area 52, where the outer folded portions 61A to 64A are not completely extendable even in the worn state.

In the state where the mask 10 is worn, the central area 14 of the mask body 20 is extended by the extension area of the pleat portion 60 in accordance with the vertical length of the wearer's face (length from nose to chin) and the vertical dimension (dimension in the vertical direction Y) becomes large, while the outer folded portions 61A to 64A are not completely extended and the both side areas 15 are only slightly extended as compared with before the mask is worn.

When the mask 10 is worn, after the ear looping strap 30 is put on around the ear, the lower end portion 22 of the mask body 20 is pulled downwardly to extend the plurality of pleat portions 60.

At this time, the ear looping strap 30 pulls the first to fourth pleat portions 61 to 64 downward with the upper and lower end portions 21 and 22 of the mask body 20 in contact with the face to extend the respective extension areas, and the vertical dimension of the central area 14 of the mask body 20 is increased.

In a case where the central part 25 of the lower end edge 20b of the mask body 20 extends linearly in the width direction X as indicated by the imaginary line K1 illustrated in FIG. 2, in the state before wearing, the vertical dimension of the central area 14 and the vertical dimension of both side areas 15 of the mask body 20 are the same as each other.

For example, in the case where the wearer is a child whose chin is round and relatively small, when the pleat portion 60 of the mask body 20 is extended, the central part 25 linearly extending in the width direction X extends downwardly from both side parts thereof, that is, when the vertical dimension of the central area 14 of the mask body 20 is larger than the vertical dimension of the both side areas 15, the lower end portion 22 of the mask body 20 becomes loose under the chin and does not fit sufficiently to cause a gap in some cases.

Further, when the lower end portion 22 is further pulled in order to eliminate such a loose condition, it becomes closer to the throat, which may cause discomfort especially to the child wearer.

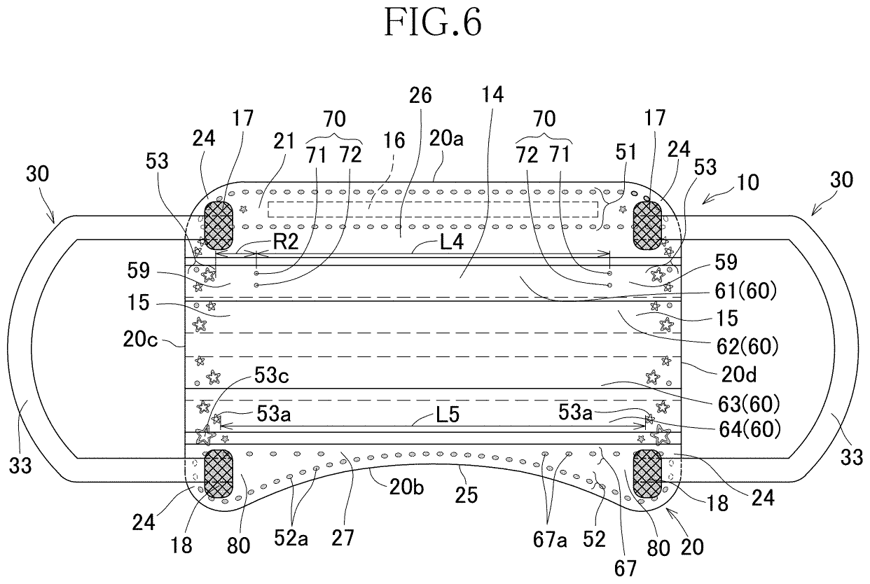

Referring to FIG. 6, in the disposable mask 10 according to one or more embodiments, since the lower end edge 20b of the mask body 20 has a central part 25 which is curved upwardly, the vertical dimension of the central area 14 of the mask body 20 is adjusted to be small before being extended, and therefore the lower end portion 22 fits under the chin in a substantially linear state without a loose condition of the lower end edge 20b when it is extended and the vertical dimension is increased.

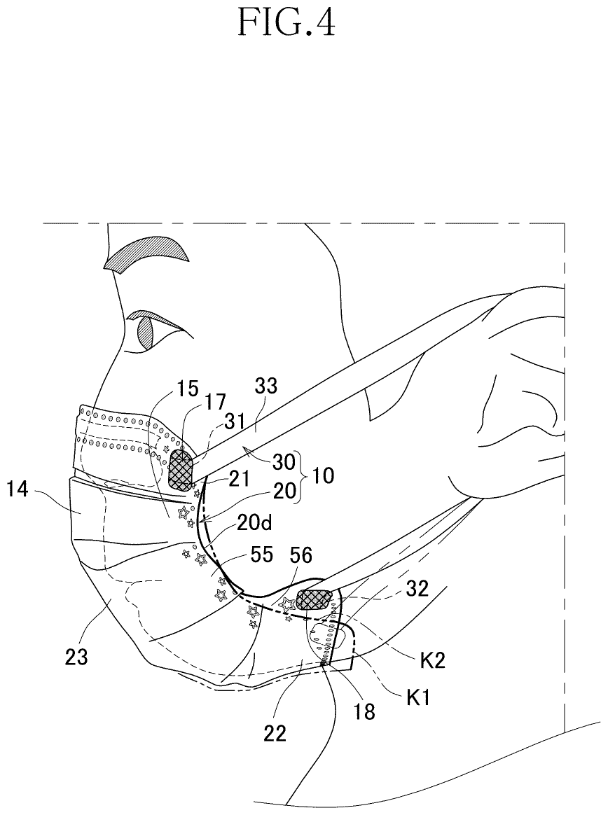

FIG. 4, in a non-wearing state, indicates by double-dashed lines the imaginary line K1, and the imaginary line K2 representing the side edge 20d of the mask body 20 in a case where the central part 25 extends linearly in the width direction X along the imaginary line K1.

In a case where the central part 25 is linear along the imaginary line K1, the dimension of the mask body 20 in the width direction X does not change significantly, and therefore the lower end portion 22 is not laterally widened.

On the other hand, in the mask 10 according to one or more embodiments, the central part 25 of the lower end edge 20b has a shape being convex upwardly in the non-wearing state, but in the worn state, the extension areas of the pleat portions 61 to 64 are extended and the central part 25 is linearly deformed in the width direction X, so that the lower end portion 22 has a larger width dimension than those of the upper end portion 21 and the mouth-nose covering portion 23.

Therefore, the both side edges 20d are located outside the imaginary line K2, and the lower end portion 22 can widely cover the vicinity of the wearer's chin in such a manner as to spread laterally.

In this manner, it can be said that the lower end portion 22 can fit more stably the face by an appropriate position under the wearer's chin and widely covering the vicinity of the chin.

Referring to FIG. 2, in order to pull the lower end portion 22 downwardly so that the central part 25 of the lower end edge 20b becomes substantially linear during wearing, a part of the central part 25 may be located between the lower fixed ends 32 of the ear looping strap 30.

By locating a part of the central part 25 between the lower fixed ends 32, with the lower fixed end 32 pressed against the face as a starting point, the curved part including the central part 25 located therebetween can be effectively pulled downwardly.

Further, the uppermost portion 25c, being at the uppermost position of the central part 25, may be located below the upper edge of the lower fixed end 32 of the ear looping strap 30.

In such a case, by the lower fixed end 32 of the ear looping strap 30, a force pulling backward and in the width direction X acts on the entire curved part of the lower end portion 22 along the central part 25, so that the curved part can be surely deformed into a linear shape.

Further, in one or more embodiments, the lower fixed end 32 is located in the area 80 surrounded by the lateral seal portion 67 and the lower seal area 52.

Since the lower fixed end 32 is not overlapped with the lateral seal portion 67 and the lower seal area 52, the joining portions 52a and 67a that are sealed to be hardened are not directly pressed against the skin to cause discomfort.

Further, although the lower fixed end 32 may be partially overlapped with the joining portion 67a of the lateral seal portion 67 and/or the joining portion 52a of the lower seal area 52, even in such a case, since the joining portions 52a and 67a are independent and have a relatively small elliptical shape, even if both are overlapped with each other, the joining portions 52a and 67a are not excessively hardened and do not cause discomfort to the skin.

In one or more embodiments, the third and fourth pleat portions 63 and 64 are provided as the lower pleat portions, and the vertical dimension before extending the third and fourth pleat portions (the total dimension of the vertical dimension of the third pleat portion 63 and the vertical dimension of the fourth pleat portion 64) is 20 to 30 mm.

Therefore, when the extension areas are completely extended, the total vertical dimension is 55 to 65 mm so that the wearer's chin can be covered.

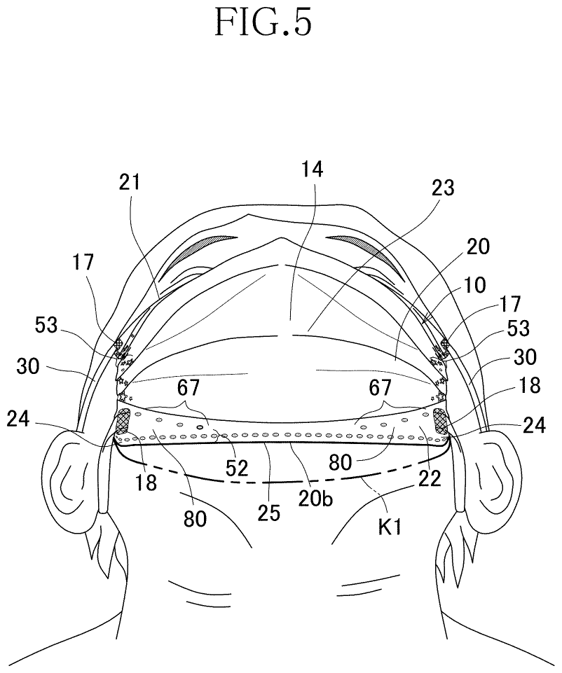

Referring to FIG. 5, since the imaginary line K1 is located below the chin toward the wearer's throat, there is a possibility that the child may feel uncomfortable; whereas, in one or more embodiments, since the central part 25 has a convex curved shape, the central part 25 extends substantially linearly in the width direction X at an appropriate position under the chin.

Specifically, since the central part 25 is spaced apart from the lower side edge of the mandible by about 15 to 25 mm, the chin can be stably covered, and a part of the lower end portion 22 does not give discomfort such as digging into the throat.

A curvature degree of the central part 25 of the lower end edge 20b can be adjusted appropriately depending on the vertical length of the wearer's face, for example, in the case of an adult mask, since the face is vertically longer than that of a child, it is not necessary to greatly adjust the vertical dimension of the central area 14 after wearing, and the curvature degree is smaller than that of a child mask.

Again referring to FIG. 2, for example, in a case where the mask 10 is for children and the dimension L3 of the imaginary line K1 is 105 to 125 mm, the vertical dimension of the central part 25, that is, a spaced dimension R1 in the vertical direction Y between the uppermost portion 25c and the imaginary line K1 that connects the both ends 25a and 25b of the central part 25 and extends linearly in the width direction X may be 5 to 15 mm or 8 to 15 mm for the mask 10 for children. In other words, in the mask 10 for children, the uppermost portion 25c and the imaginary line K1 may be spaced apart by 5 to 15 mm or 8 to 15 mm in the vertical direction Y. The spaced dimension R1 may be 5 to 25 mm for the mask 10 used both for children and adults.

Although not shown, decorative elements may be placed on the outer surface of the mask body 20 so that the wearer can easily distinguish the inner and outer surfaces of the mask 10.

The decorative element can be formed by subjecting the basic body sheet to a printing process, for example, appropriately adopting a character imitating an animal, various known figures, decorative patterns, pictures, characters, symbols, and colored parts different from the mask body.

### <Measurement of Mask Wearing Level>

The following measurements were performed regarding the wearing level of the mask (degree of contact area with the face of the wearer) by setting the mask (for children) according to one or more embodiments as Example 1, a mask having a configuration similar to that of the mask according to one or more embodiments and extending linearly in the width direction X such that the central part 25 of the lower end edge 20b is along the imaginary line K1, as Comparative Example 1, and a mask having a form basically similar to that of Comparative Example 1, and having a non-woven fabric sheet fixed separately from the body sheet so as to wrap around both side edge portions of the mask body, as Comparative Example 2.

In the mask of Comparative Example 2, in order to stably fix the separate non-woven fabric sheet, a joining portion that forms the side seal area is disposed over the entire pleat portions, and an elastic strip (nose fit) is not disposed at the upper end portion of the mask body.

The procedure of the measuring method is to be described. First, a sample of each mask was worn to a doll having a standard child's head size, and after adjusting the shape for about 1 minute, it was removed.

Next, coloring materials (for example, a commonly used skin color foundation for women's makeup) were applied on a part of the doll where the mask is in close contact (for example, the nose, the lower parts of both eyes, the cheek, the chin, the part under the chin).

Next, each sample was worn on a proper position of the doll for 30 seconds, and the coloring materials were transferred to the inner surface side thereof.

Next, the sample in which the coloring material was transferred to the inner surface side was removed from the doll, placed on the measuring table with the inner surface side facing upward, and a 1-yen coin (mass of 0.20 g, area of 3.14 cm²) was placed in the almost center part of the inner surface.

In this state, the sample was photographed from directly above by a digital camera, and a color photograph was printed out from the printer.

An area A of the 1-yen coin and a contact area B, which is the total area of the part to which the coloring material was transferred, were cut out from the printed color photograph, and the weights thereof were measured.

The contact area B (cm²) was calculated from the ratio of the weight of the area A to the weight of the contact area B, assuming that the area of the 1-yen coin was 3.14 cm².

The same measurement was performed three times for each of the samples of Example and Comparative Examples 1 and 2, and the average value was obtained as the contact area B (cm²) in each mask.

As a result of such measurement, the contact area B of the mask according to the Example was 33.2 cm², the contact area B of Comparative Example 1 was 31.2 cm², and the contact area B of the Comparative Example 2 was 19.7 cm².

When comparing the Example with Comparative Example 1, since the central part 25 of the lower end edge 20b of the mask 10 according to the Example has a shape being convex upwardly, although the area of the mask 10 according to the Example before wearing is smaller than the area of the mask according to Comparative Example 1, the contact area B of the mask 10 according to the Example is larger than the contact area B of the mask according to Comparative Example 1.

The reason for this is that in the mask according to Comparative Example 1, the tensile force of the ear looping strap is difficult to be transferred to a part facing the wearer's chin, and it comes into a state of raising from the skin; whereas, in the mask according to the Example, the lower end portion 22 is in widely contact with the face due to the central part 25 having a shape being convex upwardly, and in addition, the vertical dimension of the central part 14 of the mask body 20 is reduced, the tensile force of the ear looping strap 30 is easily transferred to the entire part facing the chin, and the contact area with the chin is increased.

The contact area B of the mask according to Comparative Example 2 is the smallest among the masks of Example and Comparative Examples 1 and 2. The reason for this is that in the mask according to Comparative Example 2, similar to the mask according to Comparative Example 1, the part on the chin side did not sufficiently contact the skin as compared with the mask according to the Example, and in addition, a non-woven fabric sheet separate from the base sheet is fixed to both side edge portions of the mask body, and by disposing the joining portion of the side seal area over the entire pleat portion, both side edge portions of the mask body are too hardened to follow the contour of the cheek, and the mask body 20 raised from both sides of the nose due to the limited extension of each pleat portion and the absence of elastic strips at the upper end portion of the mask body.

As mentioned above, the masks according to the Example have a larger contact area B than the masks according to Comparative Examples 1 and 2, and are excellent in wearing feeling, and in particular, the contact area at the chin is large, and thereby it is possible to suppress the displacement due to the movement of the mouth and the chin.

### Second Embodiment

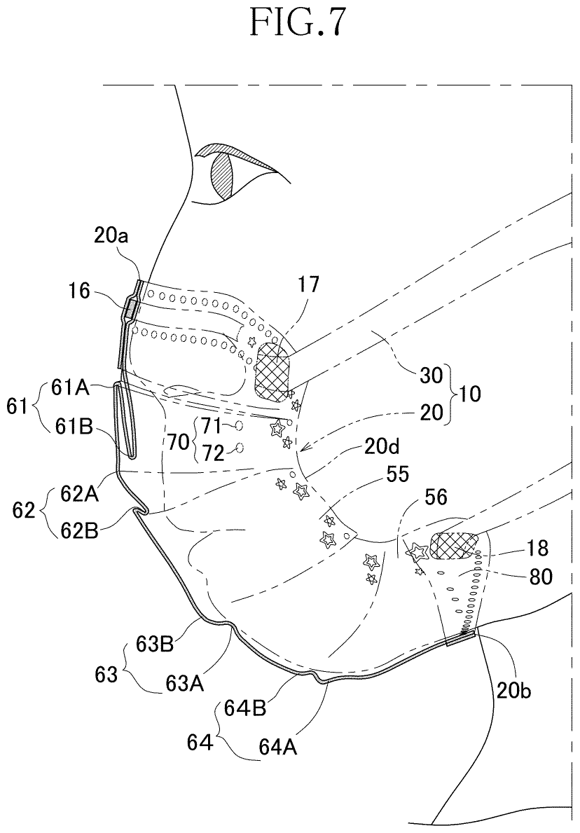

FIG. 6 is a plan view of a disposable mask according to a second embodiment, and FIG. 7 is a cross-sectional view of the disposable mask according to the second embodiment.

The first pleat portion 61 is provided with a pair of pleat adjustment joining portions 70 (pleat adjusting means) which are spaced apart and opposed to each other in the width direction X.

The pleat adjustment joining portion 70 is located on the inner side in the width direction X with respect to the both side edges 20c and 20d of the mask body 20 and a side seal area 53, and joins the body sheets opposed to each other in the thickness direction.

In this way, by arranging the pair of pleat adjustment joining portions 70 in the first pleat portion 61, in the first pleat portion 61, the part extending in the width direction X between the pair of pleat adjustment joining portions 70 is an extension area that is extendable in the vertical direction Y during wearing.

As long as the overlapped parts of the body sheets folded so as to be opposed to each other in the thickness direction are maintained in the folded state, the pleat adjusting means may be formed by sealing with known sealing means such as a heat embossing treatment or an ultrasonic treatment, and in addition, the overlapped parts may be bonded with each other using a known adhesive, or the folded state may be maintained by entangling the constituent fibers.

On the other hand, in the second to fourth pleat portions 62 to 64, since the pleat adjustment joining portion 70 is not disposed, the area between the side joining portions 53a to 53c forming the side seal area 53 is an extension area that is extendable in the vertical direction.

Specifically, the extension area is the area between the side joining portions 53a to 53c located on the innermost side in the width direction X among the side joining portions 53a to 53c located in the pleat portions 62 to 64.

For example, in the fourth pleat portion 64, the extension area is the area between the side joining portions 53a located on the innermost side in the width direction X (the area extending in the width direction between the inner edges of the side joining portions 53a to 53c).

Referring to FIG. 6, since the pleat adjustment joining portion 70 is disposed on the first pleat portion 61, the width dimension L4 of the extension area thereof is smaller than the width dimension L5 of the extension area of the fourth pleat portion 64.

Further, in the mask 10 according to one or more embodiments, the central area 14 of the mask body 20 is an area where the extension areas of the first to fourth pleat portions 61 to 64 are located, that is, an area where the extension area of the first pleat portion 61 is located, and the both side areas 15 are areas located between the extension area of the first pleat portion 61 and the both side edges 20c and 20d of the mask body 20.

In the first pleat portion 61, a side non-joint area 59 in which the side joining portions 53a to 53c are not arranged is located between the side seal area 53 and the pleat adjustment joining portion 70 in the width direction X.

Since the side non-joint area 59 is located between the side seal area 53 and the pleat adjustment joining portion 70, both side edge portions of the mask body 20 have a required flexibility to suppress discomfort during wearing due to hardening by joining a plurality of sheets.

However, as long as the both side areas 15 of the mask body 20 are along the contour of the wearer's cheek and have a sheet rigidity enough to not raise from the cheek, the side joining portions 53a to 53c may be arranged between the side seal area 53 and the pleat adjustment joining portion 70 so that the side non-joint area 59 is not formed.

In general, in a case of putting on a mask having a plurality of pleat portions formed by folding the body sheet in a pleated shape, after putting the free portion of the ear looping strap around the wearer's ear, the lower end portion of the mask body is pinched with a finger and pulled downwardly to extend each pleat portion.

At this time, it is not the nose but the mouth that moves in the wearer's face, the mask may be put on in a state in which the entire lower pleat portion is extended so that a space is created around the mouth during putting on the mask to prevent the mask from sticking to the mouth.

However, when the lower end portion of the mask body is pinched and pulled downwardly, it is not possible to control which pleat portion extends first, and the upper pleat portion expands before the lower pleat portion in some cases.

In such a case, when the wearer's face is relatively small in the vertical direction, the vertical dimension of the central area of the mask body is adjusted according to the vertical length of the face after the upper pleat portion is completely extended. Therefore, the lower pleat portion is in a state of being in contact with the chin without being fully extended.

As a result, a space is not formed around the mouth, and the mask may stick to the mouth to cause discomfort to the wearer.

Referring to FIG. 7, in the mask 10 according to one or more embodiments, the pair of pleat adjustment joining portions 70 is arranged in the first pleat portion (upper pleat portion) 61, so that a dimension L4 of the extension area in the width direction is smaller than a dimension L5 of the extension area in the width direction X of the fourth pleat portion (lower pleat portion) 64, and the extension is suppressed.

Therefore, at the time of putting on the mask 10, the third pleat portion 63 and the second pleat portion 62 are sequentially extended upwardly from the fourth pleat portion 64 so that the central area 14 of the mask body 20 is widely expanded in the vertical direction, and a sufficient internal space is formed between the mask body 20 and the mouth, so that the wearer does not feel stuffy.

On the other hand, in the first pleat portion 61, since the pleat adjustment joining portion 70 is disposed so as to suppress the extension, the mask is put on in a state where the extension area is not extended at all or is slightly extended, in accordance with the vertical length of the wearer's face.

In the illustrated example, since the wearer is a child and the vertical length of the face is relatively small, the extension area of the first pleat portion 61 is hardly extended.

Further, the pleat adjustment joining portion 70 does not intersect with the outer folded portion 61A located on the outer surface side and the inner folded portion 61B located on the inner surface side of the first pleat portion 61.

In a case where the first pleat portion 61 intersects with the vertically folded portions 61A and 61B, the extension of the first pleat portion 61 is locally and completely blocked by the pleat adjustment joining portion 70, and thus the degree of extension (movability) in the extension area located between the pleat adjustment joining portions 70 is reduced, and it may not be possible to appropriately extend it according to the size of the wearer's face. However, since the pleat adjustment joining portion 70 does not intersect with both the folded portions 61A and 61B, the degree of extension can be appropriately adjusted according to the size of the wearer's face.

In this way, by locating the pleat adjustment joining portion 70 on the first pleat portion 61, when the plurality of pleat portions 60 of the mask body 20 are extended in putting on, since the pleat portions are sequentially extended from the fourth pleat portion 64 which is the lower pleat portion, the third and fourth pleat portions 63 and 64 are extended so that the mask can be securely put on in a state where the central part 25 of the lower end edge 20b extends linearly in the width direction X under the wearer's chin.

Therefore, the lower end portion 22 can cover the chin relatively wide, and the vertical dimension of the central area 14 of the mask body 20 can be appropriately adjusted according to the vertical length of the face depending on the extension degree of the first pleat portion 61.

The pair of pleat adjustment joining portions 70 extend with each other in the vertical direction Y in parallel.

For example, in a case where the pleat adjustment joining portion 70 extends gradually obliquely with directing downwardly toward the outer side in the width direction X, since the width dimension of the extension area of the first pleat portion 61 gradually increases as it goes downward, when extended, while a part on the outer folded portion 61A side is in close contact with the skin along the shape of the nose, a part on the inner folded portion 61B side has larger width dimension of the extension area than that of the part on the outer folded portion 61A side, and thereby may be loose and folded inwardly in the vicinity of the nose, which may cause the blocking of the nostril.

In one or more embodiments, since the pleat adjustment joining portions 70 extend in parallel with each other, the width dimension of the extension area of the first pleat portion 61 is almost the same in any portion, and when extended, the part on the inner folded portion 61B side is not loose in the vicinity of the nose but can be maintained in a state of being spaced apart from the nostril.

The pleat adjustment joining portion 70 has a plurality of independent joining portions 71 and 72 arranged in the vertical direction.

The pleat adjustment joining portion 70 may have a certain dimension in the vertical direction Y in order to suppress the extension of the first pleat portion 61, but when it extends continuously in the vertical direction Y, a part having a high sheet rigidity is formed in a relatively wide range, which may cause discomfort to the wearer.

In particular, since the pleat adjustment joining portion 70 is located closer to the center of the face than the side joining portions 53a to 53c, the pleat adjustment joining portion 70 may have a soft texture to the skin.

Since the pleat adjustment joining portion 70 has a plurality of independent joining portions 71 and 72 arranged in the vertical direction Y, there is no concern that a part having a high sheet rigidity is formed in a relatively wide range, which may cause a discomfort to the wearer.

Further, each of the joining portions 71 and 72 has a circular shape or an elliptical shape and cause no irritation even if it touches the wearer's cheek.

The pleat adjustment joining portions 70 are biased downwardly in the first pleat portion 61.

The mask body 20 is formed of a plurality of sheets, and the plurality of sheets are folded at the inner and outer folded portions 61A and 61B of the first pleat portion 61. In a manufacturing process, a mountain-folded outer folded portion 61A is more likely folded in a state where the sheets are misaligned than a valley-folded inner folded portion 61B.

By locating the pleat adjustment joining portion 70 so as to be biased downward to the first pleat portion 61, it is possible to reliably join all the sheets folded over each other at the part on the inner folded portion 61B side.

However, as long as all the sheets folded over each other can be joined, the pleat adjustment joining portion 70 may be located in each of the pleat portions 61 to 64, and may be located substantially in the center of or in upper side of the pleat portions 61 to 64.

As described above, since the side joining portions 53a to 53c forming the side seal area 53 are arranged so as to be spaced apart in the width direction X and the vertical direction Y, the side seal area 53 has a required flexibility, and it is possible to prevent the both side edge portions of the mask body 20 from not conforming to the face shape so as to raise from the face due to the excessively high rigidity thereof.

Moreover, since each of the pleat portions 61 to 64 is not completely joined in the side seal area 53, it can be said that the pleat portions easily extend according to the size of the wearer's face at putting on.

In addition, in the case where the width dimension L1 of the mask body 20 is 115 to 135 mm, in the first pleat portion 61, the width dimension R2 of the side non-joint area 59 located between the side seal area 53 and the pleat adjustment joining portion 70 may be 5 to 15 mm.

In a case where the width dimension R2 of the side non-joint area 59 is less than 5 mm, the width dimension of the extension area becomes relatively large, and therefore, the first pleat portion 61 and the second pleat portion 62 may extend almost simultaneously due to the force of extending the extension area.

On the other hand, in a case where the width dimension R2 of the side non-joint area 59 exceeds 15 mm, the width dimension of the extension area becomes relatively small, and the force of extending the extension area is dispersed by the pleat adjustment joining portion 70. As a result, wrinkles extending in the width direction X are formed, and the extension area may be undulated toward the vicinity of the wearer's nose, which may cause the blocking of the nostril.

Further, in a case where the width dimension R2 of the side non-joint area 59 exceeds 30 mm, the width dimension of the extension area is further reduced and the extension is almost not achieved.

### Third Embodiment

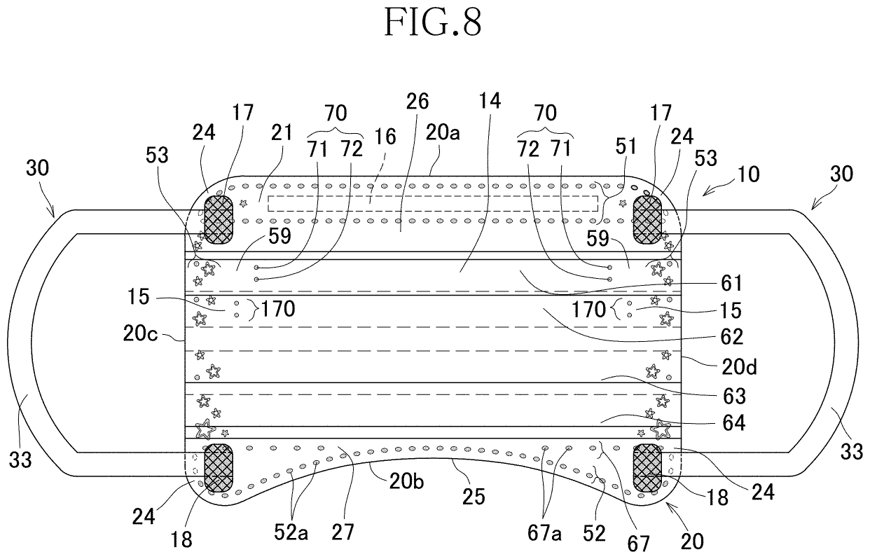

FIG. 8 is a plan view of an example of modification of the disposable mask 10 according to one or more embodiments, and in this modification, a pleat adjustment joining portion (pleat adjusting means) 170 is also disposed on the second pleat portion 62.

Since the pleat adjustment joining portions 70 and 170 are arranged on the first and second pleat portions 61 and 62, the fourth pleat portion 64 and the third pleat portion 63 are sequentially extended when putting on the mask 10. On the other hand, the second pleat portion 62 and the first pleat portion 61 do not extend or slightly extend in accordance with the size of the wearer's face, so that the dimension in the vertical direction Y of the mask body 20 can be appropriately adjusted.

In a case where the dimension of the extension area of the second pleat portion 62 in the width direction X is equal to or smaller than the dimension of the extension area of the first pleat portion 61 in the width direction X, the extension area of the first pleat portion 61 and the extension area of the second pleat portion 62 may expand simultaneously, and thus it may be difficult to adjust the vertical dimension of the central area 14 of the mask body 20 according to the vertical length of the wearer's face.

In one or more embodiments, pleat adjustment joining portions 170 located in the second pleat portion 62 are located outwardly in the width direction X than the pleat adjustment joining portions 70 located in the first pleat portion 61.

As a result, since the width dimension of the extension area of the second pleat portion 62 is larger than the width dimension of the extension area of the first pleat portion 61, when the wearer pulls the lower end portion 22 of the mask body 20 downwardly, the tensile force is widely received in the extension area of the second pleat portion 62 so that the extension area is easily extended, and before the first pleat portion 61, it can be extended to an appropriate degree according to the vertical length of the face.

Therefore, when the second pleat portion 62 and the first pleat portion 61 are extended in this order according to the size of the wearer's face, the vertical dimension of the central area 14 of the mask body 20 can be adjusted in a wider range as compared with a case where the pleat adjustment joining portions 70 are arranged only in the first pleat portion 61.

Also in one or more embodiments, since the fourth pleat portion 64, which is the lower pleat portion, can be extended first, the central part 25 of the lower end edge 20b extends linearly in the width direction X at an appropriate position under the chin so that the chin can be covered relatively widely.

In addition, from the fact that the pleat adjustment joining portion 170 of the second pleat portion 62 is formed by a plurality of independent joining portions, like the pleat adjustment joining portion 70 of the first pleat portion 61, the disposed part does not cause a discomfort by touching the face to the wearer, and the extension of the extension area is not completely suppressed.

Unless otherwise specified, as members constituting the mask 10, in addition to the materials described in the specification, known materials commonly used in this type of field can be used without limitation.

In addition, the terms “first” to “fourth” used in the present specification are used for merely distinguishing similar elements, positions, and the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.
10 disposable mask (mask)
20 mask body
20b lower end edge
20c side edge
20d side edge
25 central part
53 side joining area
53a to 53c side joining portion
60 pleat portion
61 first pleat portion (upper pleat portion, first upper pleat portion)
61A outer folded portion
61B inner folded portion
62 second pleat portion (upper pleat portion, second upper pleat portion)
63 third pleat portion (lower pleat portion)
63A outer folded portion
64 fourth pleat portion (lower pleat portion)
64B inner folded portion
70 pleat adjusting means (pleat adjustment joining portion)
71 joining portion
170 pleat adjusting means (pleat adjustment joining portion)
L4 width dimension of extension area of upper pleat portion
L5 width dimension of extension area of lower pleat portion
Q lateral centerline
R1 spaced dimension between uppermost portion and imaginary line that linearly extends in width direction connecting both ends of central part in vertical direction
X width direction
Y vertical direction

What is claimed is:

1. A disposable mask having a vertical direction and a width direction, comprising:
a mask body formed of a body sheet; and
a pair of ear looping straps that extends from both of side edges of the mask body, wherein
the mask body comprises:
a plurality of pleat portions formed by folding the body sheet in a pleated shape; and
a lower end edge that comprises a central part that is convex upwardly.

2. The disposable mask according to claim 1, wherein
the central part is disposed in the width direction between lower fixed ends of the ear looping straps,
the central part comprises an uppermost portion disposed at an uppermost position in the central part, and
the uppermost portion is disposed below upper edges of the lower fixed ends.

3. The disposable mask according to claim 2, wherein
the mask body comprises:
a lower seal area that extends along the central part; and
lateral seal portions disposed above the lower seal area,
each of the lateral seal portions extends inwardly from each of the side edges of the mask body in the width direction, and
each of the lower fixed ends is surrounded by the lower seal area and each of the lateral seal portions.

4. The disposable mask according to claim 3, further comprising:
lower fixing portions that fix the lower fixed ends to the mask body, wherein
the lower fixing portions are overlapped with the lateral seal portions, respectively.

5. The disposable mask according to claim 2, wherein
the uppermost portion and an imaginary line are spaced apart by 5 to 15 mm in the vertical direction, and
the imaginary line linearly extends in the width direction and connects both ends of the central part.

6. The disposable mask according to claim 3, wherein
the mask body comprises a side seal area disposed along in each of the side edges,
the side seal area comprises side joining portions,
the plurality of pleat portions comprises first, second, third, and fourth pleat portions disposed in order in the vertical direction,
the second pleat portion and the third pleat portion form a folded area having a substantially Ω-shape in cross section,
the folded area comprises a central area where the body sheet is not folded,
the third pleat portion comprises an outer folded portion that extends in the width direction on an outer surface of the mask body,
the fourth pleat portion comprises an inner folded portion that extends in the width direction on an inner surface of the mask body,
the side joining portions are not disposed in the central area, and
the side joining portions are not disposed between the outer folded portion and the inner folded portion.

7. The disposable mask according to claim 1, wherein
the plurality of pleat portions comprises an upper pleat portion disposed above a lateral centerline that bisects a dimension of the mask body in the vertical direction, and
the upper pleat portion comprises a pair of pleat adjustment joining portions opposed to each other in the width direction and that suppresses an extension of the upper pleat portion.
